(19) United States
(12) Patent Application Publication
(10) Pub. No.: US 2026/0278685 A1
(43) Pub. Date: Sep. 17, 2026

(54) SYSTEM AND METHOD FOR CONVERTING CONSUMER ACTIVITIES INTO TRADABLE CARBON CREDITS

(71) Applicant: Gurjeet Singh Bhullar, Chesterfield, MO (US)

(72) Inventor: Gurjeet Singh Bhullar, Chesterfield, MO (US)

(21) Appl. No.: 19/668,055

(22) Filed: May 5, 2026

Related U.S. Application Data
(60) Provisional application No. 63/954,015, filed on Jan. 5, 2026.

(51) Int. Cl. G06Q 40/04

(52) U.S. Cl. CPC G06Q 40/049

(57) ABSTRACT

A computer-implemented system, method, and non-transitory computer-readable medium for generating tradable carbon credits from consumer activity are disclosed. Primary consumer activity data associated with a consumer account is received from independent source systems including a retail transaction system, a travel or transportation data system, and a utility consumption monitoring system. An emission factor and factor-version identifier are retrieved and used to generate quantified emissions data. A verification record is generated by evaluating the canonical activity record and quantified emissions data against predefined verification criteria including source-data authenticity, completeness, cross-source consistency, and tolerance compliance. Responsive to successful verification, a unique activity fingerprint is generated and used to query a registry for a previously issued carbon offset record. Duplicate issuance is suppressed when a match is found. Otherwise, a carbon offset record is issued, listed as a tradable carbon credit, and the linked transaction value is allocated to the consumer account.

### CROSS-REFERENCE TO RELATED PATENT DOCUMENTS

This patent application claims the benefit of priority of U.S. Provisional Application No. 63/954,015, entitled “SYSTEM AND METHOD FOR CONVERTING CONSUMER ACTIVITIES INTO TRADABLE CARBON CREDITS,” filed Jan. 5, 2026, which is hereby incorporated herein by reference in its entirety.

### TECHNICAL FIELD

The present invention relates generally to computer-implemented carbon emissions accounting and verification systems, and more particularly to systems and methods for receiving consumer activity data from multiple source systems, generating quantified emissions data, verifying such data using predefined verification criteria, preventing duplicate issuance through registry-based fingerprint validation, and generating tradable carbon credits associated with consumer activity.

### BACKGROUND

Carbon accounting systems have traditionally been developed for enterprise, industrial, or institutional use and are generally directed to emissions reporting at organizational, facility, or infrastructure levels. Such systems are not typically configured to process activity-level consumer data originating from multiple independent source systems in a manner suitable for generation of tradable carbon credits.

Consumer-oriented carbon footprint tools often rely on manual data entry, questionnaires, periodic surveys, or generalized assumptions regarding purchases, travel, and utility consumption. Because such approaches do not use authenticated source-system data at an activity level, the resulting emissions estimates may lack the accuracy, traceability, and auditability required for verified issuance of carbon offset records.

In many environments, consumer activity data is fragmented across separate and technically distinct platforms, such as retail transaction systems, travel or transportation systems, and utility monitoring systems. These systems may use different identifiers, data formats, transmission protocols, and update intervals. Conventional carbon accounting platforms do not adequately normalize and reconcile such heterogeneous data into a machine-processable record representing a particular consumer activity.

Existing approaches also lack reliable mechanisms for validating source-data authenticity, evaluating cross-source consistency, and associating quantified emissions data with a uniquely identifiable activity instance. As a result, such approaches are vulnerable to incomplete verification, inconsistent emissions attribution, and duplicate counting of the same underlying consumer activity.

Further, conventional carbon credit generation and trading systems generally operate separately from underlying consumer activity capture and do not provide a verification-gated processing architecture that conditionally issues carbon offset records only after satisfaction of predefined verification criteria. Such systems also do not adequately prevent duplicate issuance of carbon offset records corresponding to the same consumer activity. In addition, existing systems typically do not maintain a registry-linked control mechanism capable of determining whether a previously issued carbon offset record already corresponds to a particular verified consumer activity prior to issuance of a new carbon offset record. This creates a risk of duplicate issuance, double counting, and inconsistent registry records.

For example, systems such as those described in U.S. Patent Application Publication No. 2021/0279777 A1 monitor consumer transactions, determine lifecycle greenhouse-gas emissions associated with those transactions, and provide carbon offsets corresponding to a consumer's carbon footprint. However, such approaches do not describe a verification-gated architecture that receives primary consumer activity data from multiple independent source systems, normalizes the received data into a canonical activity record, generates a unique activity fingerprint for the activity record, queries a registry using the unique activity fingerprint prior to issuance, and suppresses duplicate issuance of a carbon offset record when a previously issued carbon offset record already corresponds to the same consumer activity.

Accordingly, there exists a need for a computer-implemented system and method capable of receiving consumer activity data from multiple independent source systems, normalizing the received data into canonical activity records, generating quantified emissions data, verifying such data against predefined verification criteria, preventing duplicate issuance through registry-based activity fingerprint validation, and generating tradable carbon credits from verified consumer activity.

### TECHNICAL PROBLEM ADDRESSED

Conventional carbon accounting and carbon offset systems are not configured to reliably generate tradable carbon credits from activity-level consumer data received from multiple independent source systems. In many implementations, consumer-related emissions determinations are based on self-reported information, generalized estimates, or isolated transaction records that lack source authentication, cross-source validation, and machine-auditable traceability. As a result, such systems are unsuitable for controlled issuance of carbon offset records linked to specific consumer activities.

A further technical problem arises because consumer activity data is typically distributed across heterogeneous source systems, including retail transaction systems, travel or transportation data systems, and utility consumption monitoring systems, which may use different identifiers, data formats, transmission protocols, and update intervals. Conventional systems do not adequately normalize such data into canonical activity records that can be consistently processed for emissions quantification, verification, and registry-controlled issuance.

Another technical problem is the absence of effective duplicate-suppression controls for carbon offset issuance at the consumer activity level. Without a mechanism for generating an activity-specific fingerprint, querying a registry prior to issuance, and suppressing issuance when a previously issued carbon offset record already corresponds to the same underlying activity, conventional systems remain vulnerable to duplicate issuance, double counting, and inconsistent registry records.

The present invention addresses these technical problems by providing a computer-implemented architecture configured to receive primary consumer activity data from multiple independent source systems, normalize the received data into canonical activity records, retrieve emission factors for generation of quantified emissions data, generate verification records based on predefined verification criteria, generate unique activity fingerprints for verified activity records, query a registry using the unique activity fingerprints prior to issuance, suppress duplicate issuance when a matching previously issued carbon offset record is identified, and issue carbon offset records for listing as tradable carbon credits. In some embodiments, transaction-derived value associated with the issued carbon offset records is allocated to a consumer account associated with the verified activity.

### SUMMARY

It will be understood that this disclosure is not limited to the particular systems, and methodologies described, as there can be multiple possible embodiments of the present disclosure which are not expressly illustrated in the present disclosure. It is also to be understood that the terminology used in the description is to describe the particular versions or embodiments only and is not intended to limit the scope of the present disclosure.

The present invention provides a computer-implemented system, method, and non-transitory computer-readable medium for generating tradable carbon credits from consumer activity. In one embodiment, primary consumer activity data associated with a consumer account is received from a plurality of independent source systems including at least two of a retail transaction system, a travel or transportation data system, and a utility consumption monitoring system. The received data is normalized into a canonical activity record including an activity identifier, a source-system identifier, a timestamp, a quantified activity parameter, and an account association identifier corresponding to the consumer account.

In another embodiment, an emission factor corresponding to the canonical activity record and a factor-version identifier associated with the emission factor are retrieved, and quantified emissions data representing carbon emissions or carbon emission savings is generated by applying the emission factor to the quantified activity parameter.

In another embodiment, a verification record is generated by evaluating the canonical activity record and the quantified emissions data against predefined verification criteria including source-data authenticity, required-field completeness, cross-source consistency, and tolerance-threshold compliance. Responsive to the verification record indicating satisfaction of the predefined verification criteria, a unique activity fingerprint is generated for the canonical activity record.

In yet another embodiment, a registry is queried using the unique activity fingerprint to determine whether a previously issued carbon offset record already corresponds to the canonical activity record. Issuance of a new carbon offset record is suppressed when a previously issued carbon offset record is identified. When no previously issued carbon offset record is identified, a carbon offset record representing a defined quantity of carbon dioxide equivalent is issued, associated with the consumer account, and written to the registry with the unique activity fingerprint.

In yet another embodiment, the issued carbon offset record is caused to be listed on a trading platform as a tradable carbon credit. In response to execution of an electronic transaction involving the tradable carbon credit, at least a portion of transaction value may be allocated to the consumer account associated with the issued carbon offset record.

Advantageously, the present invention provides a verification-gated and registry-controlled architecture for processing consumer activity data from multiple independent source systems, generating quantified emissions data, suppressing duplicate issuance of carbon offset records, and enabling traceable generation of tradable carbon credits associated with verified consumer activity.

These and other features and advantages of the present invention will become apparent from the detailed description below, in light of the accompanying drawings.

### BRIEF DESCRIPTION OF THE DRAWINGS

FIG. 1 illustrates a general implementation environment of a system for converting consumer activities into tradable carbon credits, in accordance with an exemplary embodiment of the present invention;

FIG. 2 illustrates an example system architecture for converting consumer activities into tradable carbon credits, in accordance with an exemplary embodiment of the present invention;

FIG. 3 illustrates an example data collection and normalization flow showing collection of consumer activity data from purchase systems, travel data sources, and utility providers, according to one embodiment of the present invention;

FIG. 4 illustrates an example process flow for retrieving emission factors and generating quantified emissions data based on collected consumer activity data, according to one embodiment of the present invention;

FIG. 5 illustrates an example verification process for generating a verification record by evaluating quantified emissions data and associated activity data against predefined verification criteria, according to one embodiment of the present invention;

FIG. 6 illustrates an example conversion and issuance process for conditionally generating carbon offset records from verified carbon emissions or carbon emission savings, in accordance with one embodiment of the present invention;

FIG. 7 illustrates an example value allocation process for allocating value derived from transactions involving carbon credits to a consumer account, in accordance with one embodiment of the present invention;

FIG. 8 illustrates an example process flow of a method for converting consumer activities into tradable carbon credits, in accordance with one embodiment of the present invention; and

FIG. 9 illustrates an example registry interaction flow for generating a unique activity fingerprint, querying a registry using the unique activity fingerprint, and preventing duplicate issuance of carbon offset records corresponding to a same consumer activity, in accordance with one embodiment of the present invention.

### DETAILED DESCRIPTION

As used in the specification, the singular forms “a”, “an” and “the” may also include plural references. For example, the term “an article” may include a plurality of articles. Those with ordinary skill in the art will appreciate that the elements in the figures are illustrated for simplicity and clarity and are not necessarily drawn to scale. There may be additional components or processes described in the foregoing application that are not depicted on the described drawings. In the event, such a component or process is described, but not depicted in a drawing, the absence of such component and process from the drawings should not be considered as an omission of such design from the specification.

Before describing the present invention in detail, it should be observed that the present invention utilizes a combination of components or processes, which constitutes a system for generating a tradable carbon-credit record from consumer activity. Accordingly, the components or processes have been represented, showing only specific details that are pertinent for an understanding of the present invention so as not to obscure the disclosure with details that will be readily apparent to those with ordinary skill in the art having the benefit of the description herein. As required, detailed embodiments of the present invention are disclosed herein; however, it is to be understood that the disclosed embodiments are merely exemplary of the invention, which can be embodied in various forms. Therefore, specific component level details and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting but rather to provide an understandable description of the invention.

References to “one embodiment”, “an embodiment”, “another embodiment”, “one example”, “an example”, “another example”, “yet another example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment. The words “comprising”, “having”, “containing”, and “including”, and other forms thereof, are intended to be equivalent in meaning and be open ended in that an item or items following any one of these words is not meant to be an exhaustive listing of such item or items or meant to be limited to only the listed item or items. Further, the word “user” and “person” are used interchangeably in the description.

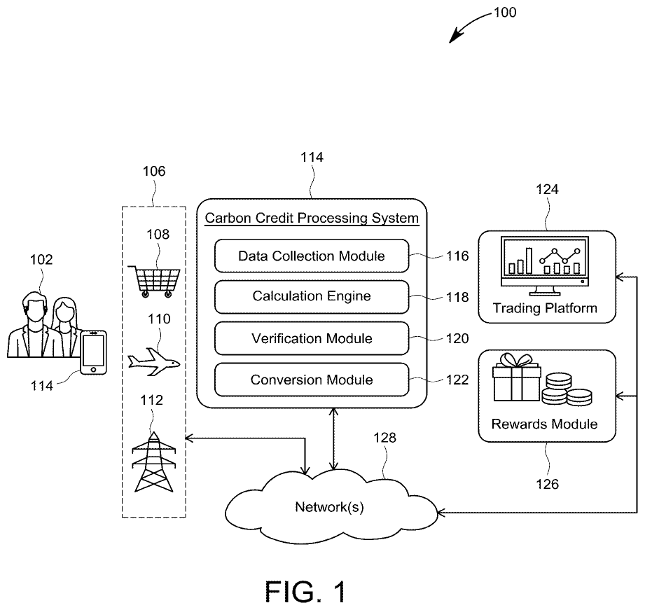

A system for generating a tradable carbon-credit record from consumer activity will now be described with reference to the accompanying drawings, particularly FIGS. 1-9.

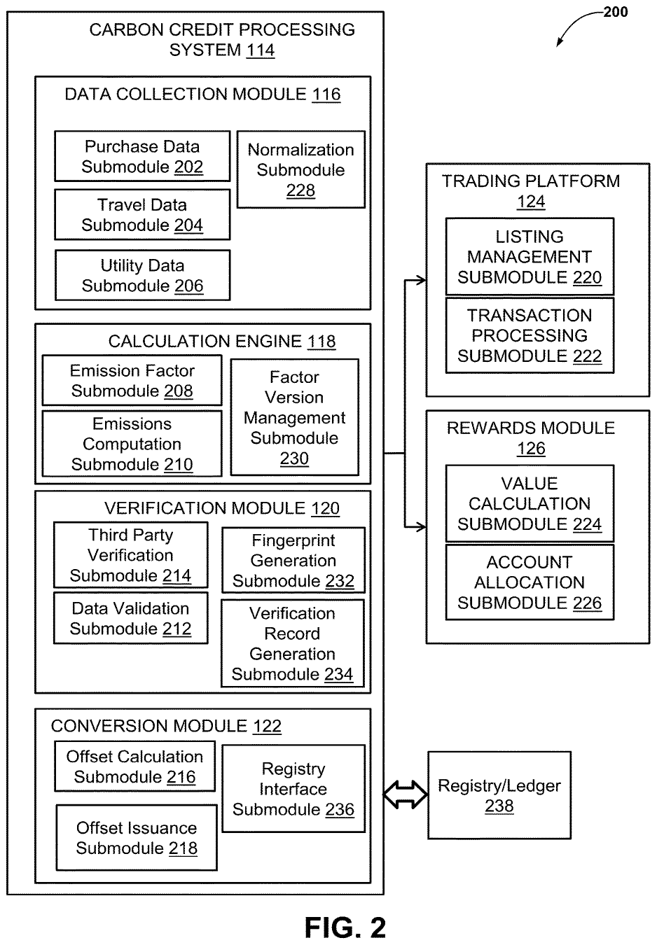

Referring to FIG. 1 in conjunction with FIGS. 2-9 illustrates a general implementation environment 100 of a system for converting consumer activities into tradable carbon credits. The environment 100 includes one or more consumers 102. Each consumer 102 may perform activities that generate carbon emissions or carbon emission savings. Such activities may include purchases of goods or services, travel activities, and utility consumption. The consumers 102 may interact with the environment 100 through one or more consumer devices 104.

The consumer devices 104 may include mobile phones, tablet computers, personal computers, wearable devices, or other computing devices capable of transmitting data. Each consumer device 104 may be configured to communicate activity data associated with the consumer 102 to one or more external systems. In some embodiments, the consumer device 104 includes an application or interface that enables monitoring or reporting of consumer activities.

The environment 100 further includes one or more data sources 106. The data sources 106 are configured to provide activity data associated with the consumer 102. The data sources 106 may include retail systems 108, travel data systems 110, and utility service systems 112.

The retail systems 108 may include point of sale systems operated by merchants. The retail systems 108 may transmit purchase data associated with goods or services acquired by the consumer 102. The travel data systems 110 may include transportation service providers, navigation systems, or location based services. The utility service systems 112 may include smart meters or utility provider databases that store consumption data.

The environment 100 further includes a carbon credit processing system 114. The carbon credit processing system 114 may comprise one or more computing systems or servers. The carbon credit processing system 114 may be implemented as a centralized platform or a distributed system. The various modules and submodules of the carbon credit processing system 114 are described in further detail with reference to the exemplary system architecture shown in FIG. 2. In some embodiments, the carbon credit processing system 114 is further configured to normalize received consumer activity data into canonical activity records, generate verification records based on predefined verification criteria, generate unique activity fingerprints for verified activity records, and query a registry prior to issuance of carbon offset records to prevent duplicate issuance.

In one or more embodiments, the carbon credit processing system 114 includes a data collection module 116 configured to collect primary consumer activity data associated with a consumer 102. As used herein, primary consumer activity data refers to activity data obtained directly from source systems that generate or record consumer activities, rather than from user surveys, manual user input, or estimated behavioral profiles.

In some embodiments, the primary consumer activity data includes purchase data received directly from retail systems 108, travel or transportation data received directly from travel data systems 110, and utility consumption data received directly from utility service systems 112. The primary consumer activity data may be received at a transaction-level, trip-level, or usage-interval level and may include associated activity identifiers, timestamps, quantities, and source identifiers.

In certain embodiments, the primary consumer activity data is received by the data collection module 116 via authenticated communication interfaces, including application programming interfaces (APIs) exposed by the data sources 106, digitally signed data feeds, or secure data exchange protocols. The data collection module 116 may validate source authenticity and data integrity prior to forwarding the primary consumer activity data to a calculation engine 118.

In some embodiments, the data collection module 116 receives primary consumer activity data asynchronously from a plurality of independent data sources 106 and associates the received data with a consumer account using one or more consumer identifiers or device identifiers. The data collection module 116 may normalize, aggregate, or format the received primary consumer activity data for subsequent processing by the calculation engine 118 and a verification module 120.

As shown in FIG. 1, the carbon credit processing system 114 includes the calculation engine 118. The calculation engine 118 is configured to quantify carbon emissions or carbon emission savings associated with the activity data. The calculation engine 118 may apply standardized emission factors obtained from recognized emissions databases. In some embodiments, the calculation engine 118 determines emissions at a transaction level.

As shown in FIG. 1, the carbon credit processing system 114 includes the verification module 120 that is configured to verify quantified carbon emissions or carbon emission savings prior to issuance of carbon offset records. The verification module 120 receives quantified carbon emissions or carbon emission savings generated by the calculation engine 118 and generates a verification record corresponding to each quantified result.

The verification record generated by the verification module 120 represents a machine-readable determination of whether predefined verification criteria have been satisfied for the quantified carbon emissions or carbon emission savings. The verification criteria may include, without limitation, validation of data authenticity of consumer activity data received by the data collection module 116, consistency checks across activity identifiers and timestamps, reconciliation between multiple independent data sources 106, and compliance with predefined tolerance thresholds or validation rules.

In some embodiments, the verification record includes a verification state selected from a plurality of verification states comprising verified, conditionally verified, and rejected. The verification state indicates whether the quantified carbon emissions or carbon emission savings are eligible for conversion into carbon offset records.

In one or more embodiments, the carbon credit processing system 114 includes a conversion module 122. The conversion module 122 is configured to convert verified carbon emissions or carbon emission savings into one or more carbon offsets. Each carbon offset may represent a defined amount of carbon dioxide equivalent. Further, the conversion module 122 is configured to issue one or more carbon offset records only when the verification state associated with the verification record is verified. Quantified carbon emissions or carbon emission savings associated with a verification record having a verification state other than verified are not converted into carbon offset records and are prevented from being listed as tradable carbon credits on a trading platform 124.

In some embodiments, the trading platform 124 comprises a regulated carbon credit exchange, a voluntary carbon marketplace, or a private trading environment accessible to authorized participants. The trading platform 124 may interface with one or more registries to track ownership, transfer, and retirement of issued carbon offset records.

In certain embodiments, the verification module 120 generates and stores a timestamped audit trail in association with the verification record. The audit trail may include identifiers associated with the consumer 102, the consumer account, activity identifiers corresponding to consumer activity data, identifiers of the data sources 106 used for verification, applied verification criteria, and the resulting verification state. The audit trail enables subsequent auditing, reporting, dispute resolution, or regulatory compliance.

In some embodiments, the verification module 120 is further configured to prevent duplicate issuance of carbon offset records by generating or receiving a unique activity fingerprint corresponding to the consumer activity data. The unique activity fingerprint may be derived from one or more of transaction identifiers, timestamps, source identifiers, and consumer account identifiers.

Prior to issuance of a carbon offset record, the verification module 120 or the conversion module 122 queries a registry or ledger to determine whether a carbon offset record has previously been issued for the same unique activity fingerprint. If a prior issuance is identified, the verification state associated with the verification record is set to rejected, thereby preventing issuance of a duplicate carbon offset record and preventing duplicate trading of carbon credits.

In some embodiments, the registry or ledger comprises a data store configured to persistently record issued carbon offset records, unique activity fingerprints, offset identifiers, and associated consumer account references. The registry may be implemented as a centralized database, a distributed ledger, or a hybrid architecture. Prior to issuance of a carbon offset record, the registry is queried using the unique activity fingerprint to determine whether a corresponding offset record has already been issued. If a match is detected, issuance is prevented to avoid duplicate carbon credit generation.

In one or more embodiments, the carbon credit processing system 114 is configured to prevent duplicate issuance of carbon offset records corresponding to the same consumer activity. To achieve this, the verification module 120 and/or the conversion module 122 generates or receives a unique activity fingerprint corresponding to consumer activity data collected by the data collection module 116.

The unique activity fingerprint uniquely represents a specific instance of consumer activity and may be derived from one or more of transaction identifiers, timestamps, source identifiers associated with the data sources 106, and identifiers associated with the consumer 102 or the consumer account. The unique activity fingerprint is generated prior to issuance of any carbon offset record.

Prior to issuing a carbon offset record, the conversion module 122 queries an internal registry or an external registry to determine whether a carbon offset record has previously been issued for the same unique activity fingerprint. The registry may store issued carbon offset records, associated offset identifiers, activity fingerprints, and consumer account references.

If the registry query indicates that a carbon offset record has already been issued for the unique activity fingerprint, issuance of a new carbon offset record is prevented. In such cases, the verification module 120 sets the verification state associated with the verification record to rejected, thereby preventing duplicate issuance and preventing the same consumer activity from being represented by more than one tradable carbon credit on the trading platform 124.

Each carbon offset record issued by the conversion module 122 is assigned a unique offset identifier that remains persistently associated with the consumer account and with subsequent listing, trading, and value allocation events. This ensures traceability of each issued carbon offset record throughout its lifecycle and prevents reuse or double counting of carbon offsets.

The environment 100 further includes a trading platform 124. The trading platform 124 is configured to list the carbon offsets as tradable carbon credits. The trading platform 124 may enable transactions between buyers and sellers of the carbon credits. In some embodiments, the trading platform 124 operates as a marketplace accessible through a network.

In one or more embodiments, the environment 100 further includes a rewards module 126 that is configured to automatically allocate value derived from transactions involving tradable carbon credits to a consumer account associated with a consumer 102. The rewards module 126 operates in coordination with the trading platform 124 and receives transaction information generated upon execution of transactions involving carbon offset records issued by the conversion module 122. The components of the environment 100 may communicate through one or more networks 128. The networks 128 may include wired networks, wireless networks, or a combination thereof.

The transaction information received by the rewards module 126 may include identifiers of the issued carbon offset records, quantities of carbon dioxide equivalent represented by the carbon offset records, transaction value, timestamps, and identifiers associated with the consumer account. The rewards module 126 processes the transaction information to determine a portion of transaction value to be allocated to the consumer account associated with the issued carbon offset records.

In some embodiments, the rewards module 126 includes a value calculation submodule as shown in FIG. 2 as value calculation submodule 224 that is configured to programmatically calculate the portion of transaction value based on one or more predefined allocation rules. The allocation rules may consider, without limitation, the quantity of carbon dioxide equivalent represented by the issued carbon offset records, a predefined percentage of transaction proceeds, consumer participation parameters, or utilization of a consumer-specific carbon budget.

In certain embodiments, the rewards module 126 includes an account allocation submodule as shown in FIG. 2 as account allocation submodule 226 that is configured to automatically allocate the calculated portion of transaction value to the consumer account upon execution of the transaction on the trading platform 124. The allocation is performed automatically without requiring user intervention and without requiring the consumer 102 to separately request or redeem the allocated value.

The allocated value may comprise monetary proceeds derived from sale of the tradable carbon credits, digital credits, or other consideration supported by the trading platform 124. The allocated value may be stored in association with the consumer account for immediate use or later redemption. In some embodiments, the rewards module 126 generates a confirmation record indicating successful allocation of value, which may be stored for reporting, auditing, or consumer notification purposes.

This automated value allocation mechanism ensures that economic value generated from transactions involving tradable carbon credits is directly and reliably attributed to the consumer account associated with the issued carbon offset records, thereby closing the lifecycle from verified consumer activity to monetization.

In one example embodiment, a consumer 102 purchases a product using a retail system 108. Purchase data is transmitted to the data collection module 116. The calculation engine 118 quantifies carbon emissions or emission savings associated with the purchase. The verification module 120 verifies the quantified result. The conversion module 122 generates a carbon offset. The carbon offset is listed on the trading platform 124 as a carbon credit. Value derived from a transaction involving the carbon credit is allocated to the consumer 102 through the rewards module 126.

FIG. 2 illustrates an example system architecture 200 for converting consumer activities into tradable carbon credits in accordance with one embodiment of the invention. The system architecture 200 may be implemented within the example environment 100 shown in FIG. 1.

The system architecture 200 includes the carbon credit processing system 114. The carbon credit processing system 114 is configured to receive primary consumer activity data associated with one or more consumer accounts from one or more external data sources 106 and to generate tradable carbon credits based on verified consumer activity data. As shown in FIG. 2, the carbon credit processing system 114 includes the data collection module 116. The data collection module 116 is configured to receive primary consumer activity data from one or more data sources 106 and, in some embodiments, from consumer devices 104. The primary consumer activity data may include purchase data, travel data, and utility consumption data.

In one or more embodiments, the carbon credit processing system 114 is configured to receive the primary consumer activity data from external data sources 106 using authenticated communication mechanisms. The data collection module 116 may communicate with the external data sources 106 through one or more application programming interfaces (APIs), digitally signed data feeds, secure file transfer mechanisms, or other secure communication interfaces.

In certain embodiments, access to the external data sources 106 is controlled using authentication credentials, cryptographic keys, digital certificates, or token-based authentication mechanisms. The data collection module 116 may validate authentication information associated with the received primary consumer activity data to confirm that the data originates from an authorized source system.

In some embodiments, the data collection module 116 includes a purchase data submodule 202 configured to receive transaction-level purchase information from retail systems 108, a travel data submodule 204 configured to receive travel-related information from travel data systems 110, and a utility data submodule 206 configured to receive utility consumption information from utility service systems 112.

In some embodiments, the data collection module 116 further includes a normalization submodule 228 configured to normalize the received primary consumer activity data into a canonical activity record. The canonical activity record may include an activity identifier, a source-system identifier, a timestamp, a quantified activity parameter, and an account association identifier corresponding to a consumer account. The normalization submodule 228 may perform schema mapping, field standardization, timestamp normalization, and unit normalization such that activity data received from heterogeneous source systems may be processed in a common machine-readable format.

The carbon credit processing system 114 further includes the calculation engine 118. The calculation engine 118 is configured to generate quantified emissions data representing carbon emissions or carbon emission savings attributable to the canonical activity record. In an embodiment, the calculation engine 118 includes an emission factor submodule 208. The emission factor submodule 208 is configured to retrieve, store, or access emission factors corresponding to the canonical activity record. In some embodiments, the emission factor submodule 208 is further configured to associate a factor-version identifier with a retrieved emission factor.

In another embodiment, the calculation engine 118 includes an emissions computation submodule 210. The emissions computation submodule 210 applies the emission factor to the quantified activity parameter of the canonical activity record to generate quantified emissions data expressed as carbon dioxide equivalent.

In some embodiments, the calculation engine 118 further includes a factor version management submodule 230 configured to maintain factor-version identifiers, effective dates, source references, or update metadata associated with the emission factors used by the emissions computation submodule 210.

The carbon credit processing system 114 further includes the verification module 120. The verification module 120 is configured to evaluate the canonical activity record and the quantified emissions data against predefined verification criteria and to generate a verification record.

In an embodiment, the verification module 120 includes a data validation submodule 212 configured to evaluate completeness, formatting, identifier consistency, timestamp validity, and source-data authenticity associated with the primary consumer activity data and the canonical activity record.

In another embodiment, the verification module 120 includes a third party verification submodule 214 configured to cross-reference the quantified emissions data or corresponding activity data with one or more external verification services, trusted databases, registries, or audit sources.

In some embodiments, the verification module 120 further includes a verification record generation submodule 234 configured to generate a verification record indicating whether predefined verification criteria have been satisfied. The verification record may include a verification state selected from verified, conditionally verified, and rejected.

In some embodiments, the verification module 120 further includes a fingerprint generation submodule 232 configured to generate a unique activity fingerprint for a canonical activity record responsive to the verification record indicating satisfaction of the predefined verification criteria. In certain embodiments, the unique activity fingerprint is generated as a deterministic cryptographic digest based on one or more fields of the canonical activity record.

The carbon credit processing system 114 further includes the conversion module 122. The conversion module 122 is configured to conditionally generate one or more carbon offset records based on verified quantified emissions data and to prevent duplicate issuance of carbon offset records corresponding to the same underlying consumer activity.

In an embodiment, the conversion module 122 includes an offset calculation submodule 216 configured to determine a quantity of carbon offsets based on quantified emissions data representing a defined amount of carbon dioxide equivalent.

In another embodiment, the conversion module 122 includes an offset issuance submodule 218 configured to issue one or more carbon offset records only when the verification record indicates a verified state and when duplicate issuance is not identified.

In some embodiments, the conversion module 122 further includes a registry interface submodule 236 configured to query a registry or ledger using the unique activity fingerprint prior to issuance of a carbon offset record. The registry interface submodule 236 may determine whether a previously issued carbon offset record already corresponds to the same unique activity fingerprint and may suppress issuance of a new carbon offset record when a matching previously issued carbon offset record is identified.

In some embodiments, the system architecture 200 further includes a registry or ledger 238 configured to store issued carbon offset records in association with corresponding unique activity fingerprints, offset identifiers, timestamps, and consumer account references. The registry or ledger 238 may be implemented as a centralized database, a distributed ledger, or a hybrid data store.

The system architecture 200 further includes the trading platform 124. The trading platform 124 is configured to list issued carbon offset records as tradable carbon credits and to facilitate transactions involving the tradable carbon credits. In an embodiment, the trading platform 124 includes a listing management submodule 220 configured to publish available carbon credits for trading. In another embodiment, the trading platform 124 includes a transaction processing submodule 222 configured to process transactions involving the carbon credits.

The system architecture 200 further includes the rewards module 126. The rewards module 126 is configured to allocate value derived from transactions involving the carbon credits to a consumer account associated with the issued carbon offset records. In an embodiment, the rewards module 126 includes a value calculation submodule 224 configured to determine a portion of transaction value to be allocated. In another embodiment, the rewards module 126 includes an account allocation submodule 226 configured to assign the determined value to the consumer account.

In one example embodiment, primary consumer activity data received from at least two independent source systems is normalized into a canonical activity record by the normalization submodule 228. The calculation engine 118 retrieves an emission factor and a factor-version identifier and generates quantified emissions data. The verification module 120 generates a verification record and, upon successful verification, generates a unique activity fingerprint. The registry interface submodule 236 queries the registry or ledger 238 using the unique activity fingerprint prior to issuance of a carbon offset record. When no matching previously issued carbon offset record is identified, the offset issuance submodule 218 issues a carbon offset record, the issued carbon offset record is written to the registry or ledger 238, and the trading platform 124 lists the issued carbon offset record as a tradable carbon credit2

In some embodiments, the carbon credit processing system 114 maintains a carbon profile associated with each consumer 102. The carbon profile stores and aggregates activity data, quantified carbon emissions, carbon emission savings, verification status, generated carbon offsets, carbon credit transaction data, and allocated value associated with the consumer 102. In an embodiment, the carbon credit processing system 114 maintains carbon budgets associated with consumers 102.

In some embodiments, the carbon budget associated with the consumer 102 is used to enable budget based alerts, budget driven recommendations, and budget adjusted rewards. The carbon credit processing system may generate alerts when quantified carbon emissions approach or exceed the carbon budget. The carbon credit processing system 114 may also generate recommendations to the consumer 102 based on remaining allowable emissions under the carbon budget, including recommendations related to purchases, travel, or utility consumption. In some embodiments, allocation of value derived from transactions involving carbon credits is adjusted based on utilization of the carbon budget. The carbon budget may further represent a regulatory compliance budget assigned in accordance with applicable emissions standards, an enterprise assigned budget associated with an organization or employer, or a personal sustainability target defined by the consumer 102. The carbon budget may be tracked, updated, and reported over time for monitoring, analysis, or subsequent processing.

FIG. 2 illustrates one example architecture. Additional modules or submodules may be included, and certain modules may be combined, subdivided, or omitted without departing from the scope of the invention.

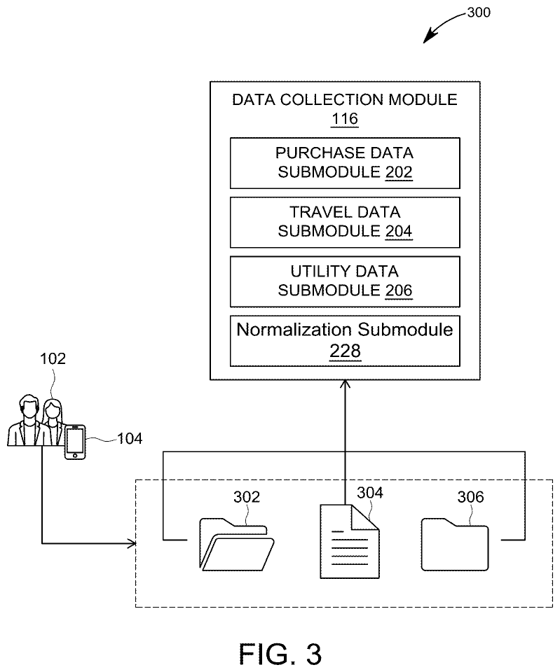

FIG. 3 illustrates an example data collection flow 300 for collecting and normalizing primary consumer activity data in accordance with one embodiment of the invention. The data collection flow 300 may be implemented within the example environment 100 shown in FIG. 1 and the system architecture 200 shown in FIG. 2.

The data collection flow 300 begins when primary consumer activity data associated with a consumer account is generated by one or more source systems. The primary consumer activity data may correspond to purchases, travel activities, or utility consumption performed by a consumer 102. In one embodiment, purchase-related activity data 302 is generated at a retail system 108. The purchase-related activity data 302 may include transaction identifiers, product identifiers, quantities, prices, merchant identifiers, and transaction timestamps.

In another embodiment, travel-related activity data 304 is generated by a travel data system 110. The travel-related activity data 304 may include distance travelled, route information, mode of transportation, trip identifiers, and corresponding timestamps.

In yet another embodiment, utility consumption activity data 306 is generated by a utility service system 112. The utility consumption activity data 306 may include electricity usage, gas usage, water usage, meter identifiers, usage intervals, and corresponding timestamps.

The purchase-related activity data 302, the travel-related activity data 304, and the utility consumption activity data 306 are transmitted to the data collection module 116. In some embodiments, the data collection module 116 receives the activity data through authenticated communication interfaces and associates the received data with a consumer account using one or more account identifiers, device identifiers, source-system identifiers, or other association metadata.

In some embodiments, the data collection module 116 normalizes the received primary consumer activity data into a canonical activity record. The canonical activity record may include an activity identifier, a source-system identifier, a timestamp, a quantified activity parameter, and an account association identifier corresponding to the consumer account. Normalization may include schema mapping, field standardization, timestamp normalization, and unit normalization for activity data received from heterogeneous source systems.

In some embodiments, the data collection module 116 aggregates or links multiple source records associated with a same underlying consumer activity prior to forwarding the canonical activity record for emissions quantification. The resulting canonical activity record may then be transmitted to the calculation engine 118 for retrieval of an emission factor and generation of quantified emissions data.

In one example embodiment, a retail system 108 transmits purchase-related activity data 302, a travel data system 110 transmits travel-related activity data 304, and a utility service system 112 transmits utility consumption activity data 306 to the data collection module 116. The data collection module 116 associates the received data with a consumer account, normalizes the received data into one or more canonical activity records, and forwards the canonical activity records to the calculation engine 118 for further processing.

FIG. 3 illustrates one example data collection and normalization flow. Additional steps may be included, and certain steps may occur in a different order without departing from the scope of the invention.

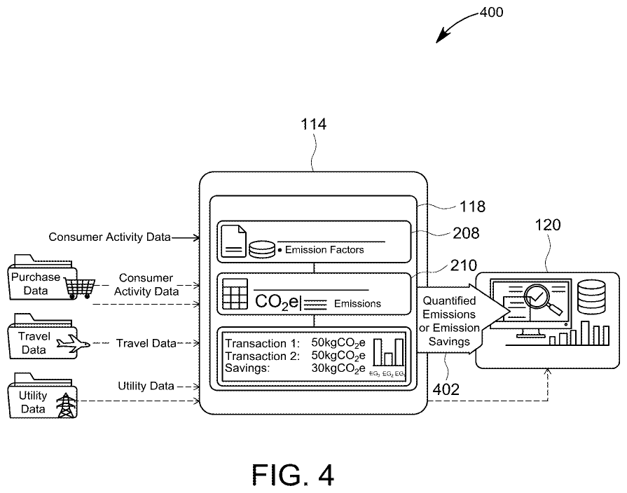

FIG. 4 illustrates an example emissions quantification flow 400 for generating quantified emissions data in accordance with one embodiment of the invention. The emissions quantification flow 400 may be implemented within the system architecture 200 shown in FIG. 2. The emissions quantification flow 400 begins when a canonical activity record generated by the data collection module 116 is received by the calculation engine 118. The canonical activity record may include an activity identifier, a source-system identifier, a timestamp, a quantified activity parameter, and an account association identifier corresponding to a consumer account.

The calculation engine 118 processes the canonical activity record to determine carbon emissions or carbon emission savings attributable to the corresponding consumer activity. Processing may occur at a per-transaction level, a per-trip level, a per-usage-interval level, or over another activity-level granularity.

In one embodiment, the calculation engine 118 includes the emission factor submodule 208. The emission factor submodule 208 is configured to retrieve, store, or access an emission factor corresponding to the canonical activity record. In some embodiments, the emission factor submodule 208 is further configured to retrieve or associate a factor-version identifier corresponding to the emission factor.

In another embodiment, the calculation engine 118 includes the emissions computation submodule 210. The emissions computation submodule 210 applies the emission factor to the quantified activity parameter of the canonical activity record to generate quantified emissions data expressed as carbon dioxide equivalent.

In some embodiments, the calculation engine 118 stores a calculation trace in association with the quantified emissions data. The calculation trace may identify the canonical activity record, the emission factor, the factor-version identifier, one or more source references, and one or more intermediate computational values used to generate the quantified emissions data.

In some embodiments, the quantified emissions data 402 is transmitted from the calculation engine 118 to the verification module 120 for evaluation against predefined verification criteria. The quantified emissions data 402 may represent carbon emissions attributable to the corresponding consumer activity or carbon emission savings determined relative to a baseline or reference value.

In one example embodiment, the data collection module 116 provides a canonical activity record corresponding to purchase data, travel data, or utility consumption data. The emission factor submodule 208 retrieves an emission factor and a factor-version identifier corresponding to the canonical activity record, and the emissions computation submodule 210 generates quantified emissions data 402 expressed as carbon dioxide equivalent. The quantified emissions data 402 is then transmitted to the verification module 120.

FIG. 4 illustrates one example emissions quantification flow. Additional processing steps may be included, and certain steps may be performed in a different order without departing from the scope of the invention.

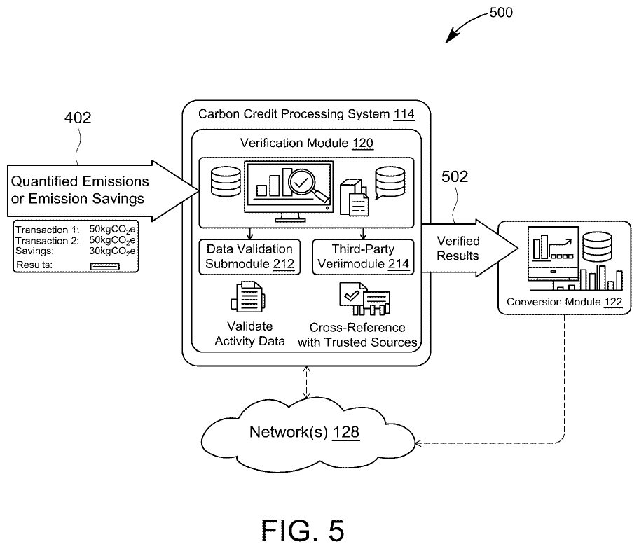

FIG. 5 illustrates an example verification flow 500 for evaluating quantified emissions data and associated activity data in accordance with one embodiment of the invention. The verification flow 500 may be implemented within the system architecture 200 shown in FIG. 2 and may receive inputs from the emissions quantification flow 400 shown in FIG. 4.

The verification flow 500 begins when quantified emissions data 402 generated by the calculation engine 118 is received by the verification module 120. In some embodiments, the verification module 120 further receives or accesses a canonical activity record corresponding to the quantified emissions data 402.

The verification module 120 evaluates the canonical activity record and the quantified emissions data 402 against predefined verification criteria. The predefined verification criteria may include source-data authenticity, required-field completeness, cross-source consistency, identifier consistency, timestamp validity, and tolerance-threshold compliance.

In one embodiment, the verification module 120 includes the data validation submodule 212. The data validation submodule 212 is configured to evaluate whether required fields are present in the canonical activity record, whether one or more identifiers and timestamps are internally consistent, and whether received source data satisfies one or more authenticity requirements. In some embodiments, source-data authenticity is evaluated by verifying a digital signature, authentication token, cryptographic checksum, certificate, or other source-authentication metadata associated with the received primary consumer activity data.

In another embodiment, the verification module 120 includes the third party verification submodule 214. The third party verification submodule 214 is configured to cross-reference the quantified emissions data 402 or corresponding activity data with one or more external verification services, trusted databases, registries, audit sources, or other reference systems.

In some embodiments, the verification module 120 evaluates cross-source consistency by comparing one or more values associated with the canonical activity record against corresponding values from another source system. The compared values may include timestamps, identifiers, quantities, route information, usage intervals, or other activity-related parameters. A mismatch exceeding a predefined threshold may cause the verification module 120 to assign a rejected state or a conditionally verified state.

In some embodiments, the verification module 120 generates a verification record based on the evaluation of the predefined verification criteria. The verification record may include a verification state indicating whether the corresponding quantified emissions data 402 is verified, conditionally verified, or rejected. In certain embodiments, the verification record may further include one or more rejection codes, exception indicators, confidence values, or audit-trace information associated with the verification process.

In some embodiments, when the verification record indicates a verified state, the corresponding quantified emissions data 402 is eligible for subsequent generation of a unique activity fingerprint and conditional issuance of a carbon offset record. When the verification record indicates a state other than verified, issuance of a carbon offset record is prevented or deferred pending correction, supplementation, or further review.

The verification module 120 verifies the quantified emissions data 402. The verified quantified emissions data 502 corresponds to a verification record. The verification record indicates a verified state. The verification module 120 transmits the verified quantified emissions data 502 to the conversion module 122. The conversion module 122 processes the verified quantified emissions data 502 further. Quantified emissions data associated with a conditionally verified state or a rejected state may be withheld from issuance processing.

In one example embodiment, the verification module 120 receives quantified emissions data 402 and a corresponding canonical activity record. The data validation submodule 212 evaluates source-data authenticity, required-field completeness, and identifier consistency, and the third party verification submodule 214 cross-references one or more values with an external source. The verification module 120 generates a verification record including a verification state. When the verification state is verified, the corresponding verified quantified emissions data 502 is forwarded for subsequent offset issuance processing.

FIG. 5 illustrates one example verification flow. Additional verification operations may be included, and certain operations may be performed in a different order without departing from the scope of the invention.

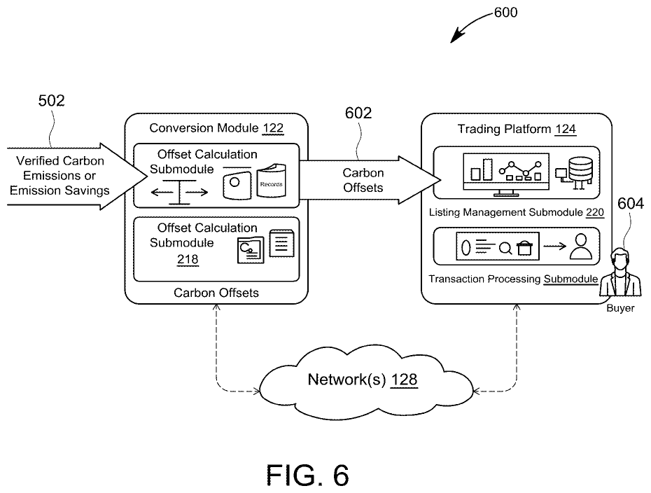

FIG. 6 illustrates an example conversion and issuance flow 600 for conditionally generating a carbon offset record from verified quantified emissions data in accordance with one embodiment of the invention. The conversion and issuance flow 600 may be implemented within the system architecture 200 shown in FIG. 2 and may receive verified quantified emissions data 502 from the verification flow 500 shown in FIG. 5.

The conversion and issuance flow 600 begins when verified quantified emissions data 502 is received by the conversion module 122. The verified quantified emissions data 502 may represent carbon emissions or carbon emission savings expressed as carbon dioxide equivalent and associated with a verification record indicating a verified state.

In one embodiment, the conversion module 122 includes the offset calculation submodule 216. The offset calculation submodule 216 is configured to determine a quantity of carbon offsets 602 corresponding to the verified quantified emissions data 502. The determined quantity may represent a defined amount of carbon dioxide equivalent and may be generated according to one or more offset methodologies, threshold rules, or rounding rules.

In another embodiment, the conversion module 122 includes the offset issuance submodule 218. The offset issuance submodule 218 is configured to issue a carbon offset record corresponding to the quantity of carbon offsets 602 only when the verified quantified emissions data 502 satisfies issuance requirements. In some embodiments, the issuance requirements include confirmation that a duplicate issuance condition has not been identified for the underlying consumer activity.

In some embodiments, the issued carbon offset record includes an offset identifier, a quantity of carbon dioxide equivalent, a timestamp, and an association with a consumer account corresponding to the underlying verified activity. In certain embodiments, the issued carbon offset record is further written to a registry or ledger in association with a corresponding unique activity fingerprint.

Upon issuance, the carbon offset record is transmitted from the conversion module 122 to the trading platform 124. The trading platform 124 is configured to cause the issued carbon offset record to be listed as a tradable carbon credit. In one embodiment, the trading platform 124 includes the listing management submodule 220 configured to publish the issued carbon offset record for trading. In another embodiment, the trading platform 124 includes the transaction processing submodule 222 configured to process transactions involving the tradable carbon credit.

In one example embodiment, verified quantified emissions data 502 associated with a consumer activity is received by the conversion module 122. The offset calculation submodule 216 determines a quantity of carbon offsets 602, and the offset issuance submodule 218 issues a corresponding carbon offset record when issuance requirements are satisfied. The issued carbon offset record is then transmitted to the trading platform 124, listed as a tradable carbon credit, and made available for transaction processing with one or more participants, such as buyer 604.

FIG. 6 illustrates one example conversion and issuance flow. Additional operations may be included, and certain operations may be performed in a different order without departing from the scope of the invention.

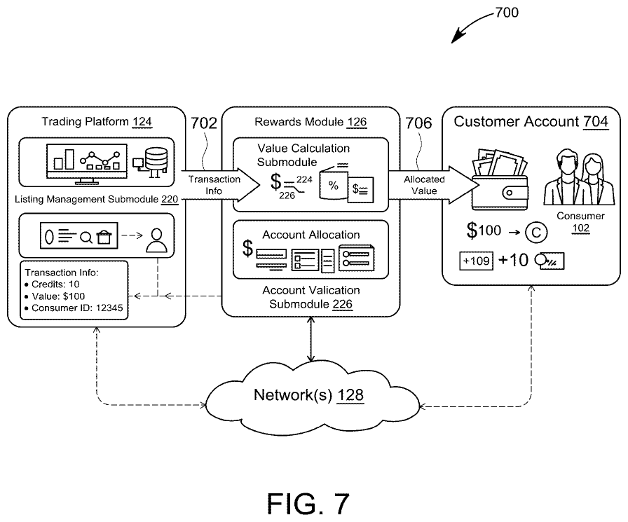

FIG. 7 illustrates an example value allocation flow 700 for allocating transaction-derived value to a consumer account in accordance with one embodiment of the invention. The value allocation flow 700 may be implemented within the system architecture 200 shown in FIG. 2 and may receive transaction information from the conversion and issuance flow 600 shown in FIG. 6. The value allocation flow 700 begins when an electronic transaction involving one or more tradable carbon credits is completed on the trading platform 124. Transaction information 702 associated with the completed electronic transaction is generated by the trading platform 124.

The transaction information 702 may include one or more offset identifiers, a quantity of carbon dioxide equivalent associated with an issued carbon offset record, transaction value, transaction identifiers, timestamps, and one or more identifiers associated with a consumer account linked to the issued carbon offset record.

The transaction information 702 is transmitted to the rewards module 126. The rewards module 126 processes the transaction information 702 to determine value 706 to be allocated to the consumer account 704 associated with the issued carbon offset record or corresponding tradable carbon credit.

In one embodiment, the rewards module 126 includes the value calculation submodule 224. The value calculation submodule 224 is configured to calculate a portion of the transaction value to be allocated based on one or more allocation rules. The allocation rules may consider the quantity of carbon dioxide equivalent represented by the issued carbon offset record, a predefined percentage of transaction proceeds, account-specific parameters, or one or more platform-defined allocation parameters.

In another embodiment, the rewards module 126 includes the account allocation submodule 226. The account allocation submodule 226 is configured to assign the calculated value 706 to the consumer account 704 associated with the issued carbon offset record. In some embodiments, the allocation is performed automatically without requiring user intervention.

The allocated value 706 may comprise a monetary amount, a digital credit, a reward unit, an account balance entry, or other consideration supported by the trading platform 124 or an associated account management system. The allocated value 706 may be stored for later redemption or made available for immediate use.

In some embodiments, the rewards module 126 generates a confirmation record indicating successful allocation of value 706 to the consumer account 704. The confirmation record may be stored for reporting, audit, reconciliation, or consumer notification purposes.

In one example embodiment, a tradable carbon credit corresponding to an issued carbon offset record is transacted on the trading platform 124. Transaction information 702 identifying the issued carbon offset record and associated transaction value is transmitted to the rewards module 126. The value calculation submodule 224 determines a portion of the transaction value to be allocated, and the account allocation submodule 226 assigns the determined value 706 to the consumer account 704 associated with the issued carbon offset record.

FIG. 7 illustrates one example value allocation flow. Additional operations may be included, and certain operations may be performed in a different order without departing from the scope of the invention.

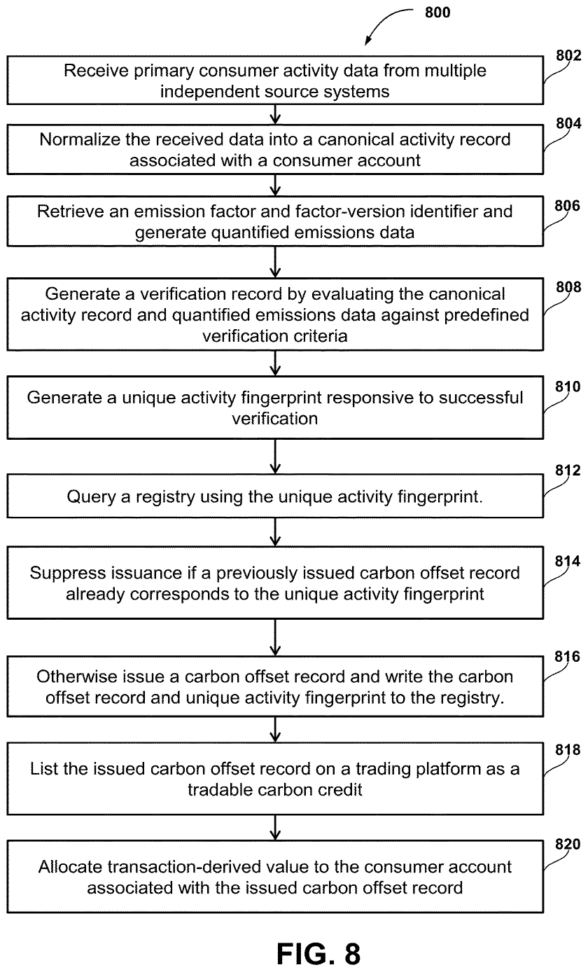

FIG. 8 illustrates an example process flow of a method 800 for generating tradable carbon credits from consumer activity, in accordance with one embodiment of the present invention. At step 802, the method 800 includes receiving, by one or more processors, primary consumer activity data associated with a consumer account from a plurality of independent source systems, the plurality of independent source systems comprising at least two of a retail transaction system, a travel or transportation data system, and a utility consumption monitoring system.

At step 804, the method 800 includes normalizing, by the one or more processors, the primary consumer activity data into a canonical activity record comprising an activity identifier, a source-system identifier, a timestamp, a quantified activity parameter, and an account association identifier corresponding to the consumer account.

At step 806, the method 800 includes retrieving, by the one or more processors, an emission factor corresponding to the canonical activity record and a factor-version identifier associated with the emission factor, and generating quantified emissions data representing carbon emissions or carbon emission savings attributable to the canonical activity record.

At step 808, the method 800 includes generating, by the one or more processors, a verification record by evaluating the canonical activity record and the quantified emissions data against predefined verification criteria including source-data authenticity, required-field completeness, cross-source consistency, and tolerance-threshold compliance.

At step 810, the method 800 includes, responsive to the verification record indicating satisfaction of the predefined verification criteria, generating, by the one or more processors, a unique activity fingerprint for the canonical activity record.

At step 812, the method 800 includes querying, by the one or more processors, a registry using the unique activity fingerprint to determine whether a previously issued carbon offset record corresponds to the canonical activity record.

At step 814, the method 800 includes suppressing issuance of a new carbon offset record when the registry indicates that the previously issued carbon offset record corresponds to the unique activity fingerprint.

At step 816, the method 800 includes issuing, by the one or more processors, when the registry indicates that no previously issued carbon offset record corresponds to the unique activity fingerprint, a carbon offset record representing a defined quantity of carbon dioxide equivalent, associating the carbon offset record with the consumer account, and writing the carbon offset record and the unique activity fingerprint to the registry.

At step 818, the method 800 includes causing, by the one or more processors, the issued carbon offset record to be listed on a trading platform as a tradable carbon credit. At step 820, the method 800 includes allocating, by the one or more processors, in response to execution of an electronic transaction involving the tradable carbon credit, at least a portion of transaction value to the consumer account associated with the issued carbon offset record.

In some embodiments, one or more of the steps of method 800 may be performed in a different order, combined, subdivided, or omitted without departing from the scope of the invention. In certain embodiments, suppression of issuance at step 814 and issuance at step 816 represent alternative outcomes responsive to the registry query performed at step 812.

The various actions, acts, blocks, steps, or the like in the flow diagram may be performed in the order presented, in a different order, or simultaneously. Further, in some embodiments, some of the actions, acts, blocks, steps, or the like may be omitted, added, modified, skipped, or the like without departing from the scope of the invention.

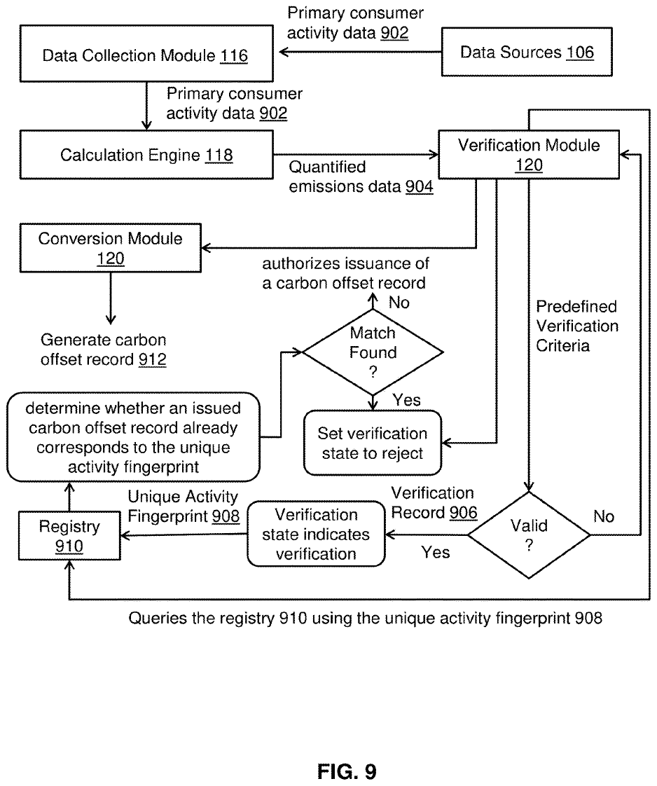

Referring now to FIG. 9, an example registry interaction flow 900 is shown for preventing duplicate issuance of carbon offset records generated from consumer activity data. The registry interaction flow 900 may operate in conjunction with the carbon credit processing system 114 described with reference to FIGS. 1 and 2.

The registry interaction flow 900 begins when the data collection module 116 receives primary consumer activity data 902 from one or more independent source systems 106. In some embodiments, the primary consumer activity data 902 includes purchase data, travel-related data, utility consumption data, or combinations thereof associated with a consumer account.

In some embodiments, the data collection module 116 normalizes the primary consumer activity data 902 into a canonical activity record. The canonical activity record may include an activity identifier, a source-system identifier, a timestamp, a quantified activity parameter, and an account association identifier corresponding to the consumer account. The data collection module 116 forwards the canonical activity record to the calculation engine 118.

The calculation engine 118 receives the canonical activity record and generates quantified emissions data 904 representing carbon emissions or carbon emission savings attributable to the canonical activity record. In some embodiments, generation of the quantified emissions data 904 includes retrieving an emission factor and a factor-version identifier corresponding to the canonical activity record and applying the emission factor to the quantified activity parameter.

The calculation engine 118 transmits the quantified emissions data 904 to the verification module 120. The verification module 120 evaluates the canonical activity record and the quantified emissions data 904 against predefined verification criteria.

In some embodiments, the predefined verification criteria include one or more of source-data authenticity, required-field completeness, cross-source consistency, identifier consistency, timestamp validity, and tolerance-threshold compliance. Based on the evaluation, the verification module 120 generates a verification record 906 indicating whether the predefined verification criteria have been satisfied.

In some embodiments, the verification record 906 includes a verification state selected from verified, conditionally verified, and rejected. When the verification state indicates verified, the verification module 120 generates a unique activity fingerprint 908 for the canonical activity record. In certain embodiments, the unique activity fingerprint 908 is generated as a deterministic cryptographic digest based on one or more fields of the canonical activity record.

The verification module 120 transmits the unique activity fingerprint 908 to a registry 910 prior to issuance of any carbon offset record. The registry 910 stores previously issued carbon offset records and associated unique activity fingerprints. The registry 910 may be implemented as a centralized database, a distributed ledger, or a hybrid data store.

The registry 910 is queried using the unique activity fingerprint 908 to determine whether a previously issued carbon offset record already corresponds to the same underlying consumer activity. In some embodiments, the query is performed by the verification module 120, the conversion module 122, or a registry interface submodule associated therewith.

If the registry 910 identifies a previously issued carbon offset record corresponding to the unique activity fingerprint 908, issuance of a new carbon offset record is suppressed. In some embodiments, the verification state associated with the verification record 906 is maintained in or changed to a rejected state, and the corresponding consumer activity is prevented from generating an additional carbon offset record.

If the registry 910 does not identify a previously issued carbon offset record corresponding to the unique activity fingerprint 908, the conversion module 122 receives an authorization to issue a carbon offset record. The conversion module 122 then generates a carbon offset record 912 representing a defined quantity of carbon dioxide equivalent and associates the carbon offset record 912 with the consumer account corresponding to the canonical activity record.

In some embodiments, the conversion module 122 records the carbon offset record 912 and the unique activity fingerprint 908 in the registry 910. The registry entry may further include an offset identifier, a timestamp, and one or more references to the consumer account or verification record 906.

After issuance, the carbon offset record 912 may be transmitted to the trading platform 124 for listing as a tradable carbon credit. In some embodiments, transaction-derived value associated with a subsequent transaction involving the tradable carbon credit may be allocated to the consumer account associated with the carbon offset record 912.

In one example embodiment, the data collection module 116 receives primary consumer activity data 902 from multiple independent source systems 106 and normalizes the received data into a canonical activity record. The calculation engine 118 generates quantified emissions data 904, and the verification module 120 generates a verification record 906 based on predefined verification criteria. When the verification record 906 indicates a verified state, the verification module 120 generates a unique activity fingerprint 908 and causes a query of the registry 910. When the registry 910 indicates that no previously issued carbon offset record corresponds to the unique activity fingerprint 908, the conversion module 122 issues the carbon offset record 912 and records the carbon offset record 912 and the unique activity fingerprint 908 in the registry 910.

The registry interaction flow 900 ensures that a particular underlying consumer activity is associated with at most one issued carbon offset record corresponding to a given unique activity fingerprint. The registry interaction flow 900 thereby reduces duplicate issuance, duplicate counting, and inconsistent registry records while enabling controlled generation of tradable carbon credits from verified consumer activity.

The present invention provides a unified and automated approach for integrating individual consumer activities into carbon emissions accounting and carbon credit generation. By directly collecting activity data from purchases, travel, and utility consumption, the invention enables accurate and granular quantification of carbon emissions or carbon emission savings. The use of standardized emission factors and verification processes improves reliability and trust in the resulting carbon offsets. Unlike conventional approaches that rely on estimates or voluntary offset purchases, the invention seamlessly links everyday consumer behavior with verified carbon credit creation, enabling broader participation by individual consumers.

In addition, the invention introduces a direct incentive mechanism by allocating value derived from transactions involving carbon credits back to consumers. This value allocation encourages sustained environmentally conscious behavior without requiring additional effort from the consumer. The integrated architecture supports scalability, auditability, and transparency across data collection, calculation, verification, trading, and value allocation. As a result, the invention improves adoption of sustainability initiatives, enhances efficiency of carbon markets, and provides a practical pathway for consumers to actively contribute to emission reduction efforts.

Although particular embodiments of the invention have been described in detail for purposes of illustration, various modifications and enhancements may be made without departing from the spirit and scope of the invention.

What is claimed is:

1. A computer-implemented method for generating a tradable carbon-credit record from consumer activity, the method comprising:
receiving, by one or more processors, primary consumer activity data associated with a consumer account from a plurality of independent source systems, the plurality of independent source systems comprising at least two of:
a retail transaction system,
a travel or transportation data system, and
a utility consumption monitoring system;
normalizing, by the one or more processors, the primary consumer activity data into a canonical activity record comprising:
an activity identifier,
a source-system identifier,
a timestamp,
a quantified activity parameter, and
an account association identifier corresponding to the consumer account;
retrieving, by the one or more processors, an emission factor corresponding to the canonical activity record and a factor-version identifier associated with the emission factor;
generating, by the one or more processors, quantified emissions data representing carbon emissions or carbon emission savings attributable to the canonical activity record by applying the emission factor to the quantified activity parameter;
generating, by the one or more processors, a verification record by evaluating the canonical activity record and the quantified emissions data against predefined verification criteria, the predefined verification criteria comprising at least one of:
source-data authenticity,
required-field completeness,
cross-source consistency, and
tolerance-threshold compliance;
responsive to the verification record indicating satisfaction of the predefined verification criteria, generating, by the one or more processors, a unique activity fingerprint for the canonical activity record;
querying, by the one or more processors, a registry using the unique activity fingerprint to determine whether a previously issued carbon offset record corresponds to the canonical activity record;
suppressing issuance of a new carbon offset record when the registry indicates that the previously issued carbon offset record corresponds to the unique activity fingerprint;
issuing, by the one or more processors, when the registry indicates that no previously issued carbon offset record corresponds to the unique activity fingerprint, a carbon offset record representing a defined quantity of carbon dioxide equivalent and associating the carbon offset record with the consumer account;
writing the issued carbon offset record and the unique activity fingerprint to the registry;
causing the issued carbon offset record to be listed on a trading platform as a tradable carbon-credit record; and
allocating, in response to execution of an electronic transaction involving the tradable carbon-credit record, at least a portion of transaction value to the consumer account associated with the issued carbon offset record.

2. The method of claim 1, wherein the predefined verification criteria require cross-validation between at least two independent data sources.

3. The method of claim 1, wherein the predefined verification criteria require source-data authenticity to be satisfied for each source system that supplies primary consumer activity data used to generate the canonical activity record.

4. The method of claim 1, wherein generating the verification record comprises assigning a verification state selected from verified, conditionally verified, and rejected.

5. The method of claim 4, wherein issuing the carbon offset record is performed only when the verification state is verified.

6. The method of claim 1, wherein evaluating the canonical activity record against the predefined verification criteria comprises verifying a digital signature, authentication token, cryptographic checksum, or certificate associated with data received from at least one of the plurality of independent source systems.

7. The method of claim 1, wherein the registry comprises an append-only ledger configured to store previously issued carbon offset records in association with corresponding unique activity fingerprints.

8. The method of claim 1, wherein the registry comprises a distributed ledger.

9. The method of claim 1, wherein the quantified activity parameter is determined at a per-transaction, per-trip, or per-usage-interval granularity.

10. The method of claim 1, wherein the emission factor is retrieved from an external emissions-factor repository through an application programming interface and is stored in association with the factor-version identifier and an effective date.

11. The method of claim 1, wherein the quantified emissions data includes a calculation trace identifying the emission factor, the factor-version identifier, and the quantified activity parameter used to generate the quantified emissions data.

12. The method of claim 1, wherein cross-source consistency comprises comparing at least one quantity value, timestamp value, location value, or activity identifier between a first source system and a second source system.

13. The method of claim 12, wherein a mismatch exceeding a predefined threshold causes the verification record to indicate the rejected state or the conditionally verified state.

14. The method of claim 1, wherein evaluating the canonical activity record against the predefined verification criteria further comprises applying a conflict-resolution rule set that weights reliability of respective source systems.

15. The method of claim 1, wherein the primary consumer activity data comprises purchase data and transportation-related data associated with delivery of a purchased product, and wherein generating the quantified emissions data includes attributing delivery-related emissions to the canonical activity record.

16. The method of claim 1, further comprising maintaining, in memory, a consumer-specific carbon profile comprising stored associations between the consumer account, one or more canonical activity records, quantified emissions data, one or more issued carbon offset records, and one or more transaction-value allocations.

17. The method of claim 16, wherein the consumer-specific carbon profile further comprises a carbon budget representing allowable emissions over a defined period.

18. The method of claim 1, wherein allocating the portion of transaction value comprises automatically crediting a monetary value, digital credit, reward unit, or account balance entry to the consumer account without requiring user intervention.

19. A system for generating a tradable carbon-credit record from consumer activity, the system comprising:
a data collection module configured to receive primary consumer activity data associated with a consumer account from a plurality of independent source systems including at least two of a retail transaction system, a travel or transportation data system, and a utility consumption monitoring system;
a normalization submodule configured to generate a canonical activity record from the primary consumer activity data;
a calculation engine configured to retrieve an emission factor and a factor-version identifier corresponding to the canonical activity record and to generate quantified emissions data from the canonical activity record;
a verification module configured to generate a verification record by evaluating the canonical activity record and the quantified emissions data against predefined verification criteria;
a fingerprint generation submodule configured to generate a unique activity fingerprint responsive to the verification record indicating satisfaction of the predefined verification criteria;
a registry interface submodule configured to query a registry using the unique activity fingerprint to determine whether a previously issued carbon offset record corresponds to the canonical activity record and to suppress issuance when a matching previously issued carbon offset record is identified;
an offset issuance submodule configured to issue a carbon offset record when the registry indicates no matching previously issued carbon offset record exists, and to write the issued carbon offset record and the unique activity fingerprint to the registry;
a trading platform interface configured to cause the issued carbon offset record to be listed as a tradable carbon-credit record; and
a rewards module configured to allocate at least a portion of transaction value to the consumer account in response to execution of a transaction involving the tradable carbon-credit record.

20. A non-transitory computer-readable medium storing instructions that, when executed by one or more processors, cause the one or more processors to:
receive, by the one or more processors, primary consumer activity data associated with a consumer account from a plurality of independent source systems, the plurality of independent source systems comprising at least two of:
a retail transaction system,
a travel or transportation data system, and
a utility consumption monitoring system;
normalize, by the one or more processors, the primary consumer activity data into a canonical activity record comprising:
an activity identifier,
a source-system identifier,
a timestamp,
a quantified activity parameter, and
an account association identifier corresponding to the consumer account;
retrieve, by the one or more processors, an emission factor corresponding to the canonical activity record and a factor-version identifier associated with the emission factor;
generate, by the one or more processors, quantified emissions data representing carbon emissions or carbon emission savings attributable to the canonical activity record by applying the emission factor to the quantified activity parameter;
generate, by the one or more processors, a verification record by evaluating the canonical activity record and the quantified emissions data against predefined verification criteria, the predefined verification criteria comprising at least one of:
source-data authenticity,
required-field completeness,
cross-source consistency, and
tolerance-threshold compliance;
responsive to the verification record indicating satisfaction of the predefined verification criteria, generate, by the one or more processors, a unique activity fingerprint for the canonical activity record;
query, by the one or more processors, a registry using the unique activity fingerprint to determine whether a previously issued carbon offset record corresponds to the canonical activity record;
suppress, by the one or more processors, issuance of a new carbon offset record when the registry indicates that the previously issued carbon offset record corresponds to the unique activity fingerprint;
issue, by the one or more processors, when the registry indicates that no previously issued carbon offset record corresponds to the unique activity fingerprint, a carbon offset record representing a defined quantity of carbon dioxide equivalent and associate the carbon offset record with the consumer account;
write, by the one or more processors, the issued carbon offset record and the unique activity fingerprint to the registry;
cause, by the one or more processors, the issued carbon offset record to be listed on a trading platform as a tradable carbon-credit record; and
allocate, by the one or more processors, in response to execution of an electronic transaction involving the tradable carbon-credit record, at least a portion of transaction value to the consumer account associated with the issued carbon offset record.
